(19) United States
(12) Patent Application Publication
(10) Pub. No.: US 2024/0001317 A1
(43) Pub. Date: Jan. 4, 2024

(54) Catalyst Feed System

(71) Applicant: Borealis AG, Vienna (AT)

(72) Inventors: Klaus NYFORS, Kullo (FI); Jouni KIVELÄ, Kullo (FI); Mubashar SATTAR, Kullo (FI); Samuli ZITTING, Kullo (FI); Erno ELOVAINIO, Kullo (FI); Mikko LYLYKANGAS, Kullo (FI); Jan LINDHOLM, Kullo (FI); Danny COX, Beringen (BE)

(73) Assignee: Borealis AG, Vienna (AT)

(21) Appl. No.: 18/254,729

(22) PCT Filed: Nov. 4, 2021
(86) PCT No.: PCT/EP2021/080598

§ 371 Date: May 26, 2023

(30) Foreign Application Priority Data
Nov. 27, 2020 (EP) 20210158.0

(51) Int. Cl. B01J 8/00; B01J 8/18; B01J 8/22; C08F 10/00

(52) U.S. Cl. CPC B01J 8/0035; B01J 8/002; B01J 8/003; B01J 8/1809; B01J 8/22; C08F 10/00; B01J 2208/0061; B01J 2208/00752

(57) ABSTRACT

The present invention relates to a process for feeding a polymerization catalyst into a polymerization reactor, said process comprising the steps of: (i) forming a catalyst slurry comprising oil and a solid catalyst component in a first catalyst preparation vessel; (ii) transferring the catalyst slurry from the first catalyst preparation vessel to a first catalyst feed vessel; (iii) maintaining the catalyst slurry in the first catalyst feed vessel in a homogeneous state; (iv) withdrawing a portion of the catalyst slurry from the first catalyst feed vessel, preferably continuously withdrawing the catalyst slurry from the first catalyst feed vessel, and introducing the withdrawn portion of the catalyst slurry into a polymerization reactor; wherein the oil has a dynamic viscosity of from 25 to 1500 mPa*s at the conditions within the first catalyst preparation vessel and the first catalyst feed vessel, wherein the catalyst slurry is transferred along a substantially vertical path downwards from the first catalyst feed vessel to the reactor.

The present application relates to a process for feeding a polymerization catalyst into a polymerization reactor, a process for producing olefin polymers in a polymerization reactor, an olefin polymer obtainable by this process and a catalyst slurry feeding system for producing olefin polymers in a polymerization reactor.

### BACKGROUND OF THE INVENTION

Prior art systems for feeding polymerization catalysts often comprise two vessels placed parallel and close to each other for feeding catalyst to a polymerization reactor. The catalyst can be prepared and fed from each tank, but in practice at a given time often one vessel is used for catalyst oil-slurry preparation and the other vessel is used for feeding. EP 3241611 discloses a process for feeding a polymerization catalyst into a polymerization reactor, comprising the steps of: (i) maintaining a catalyst slurry comprising a diluent and a solid catalyst component in a catalyst feed vessel, (ii) continuously withdrawing a stream of the catalyst slurry from the catalyst feed vessel and (iii) introducing the withdrawn portion of the catalyst slurry into the polymerization reactor. The diluent has a dynamic viscosity of from 0.01 to 20 mPa*s at the conditions within the catalyst feed vessel.

EP 1671697A1 discloses a polymerization process comprising the steps of: (i) forming a catalyst slurry in a catalyst feed vessel comprising an oil and a solid polymerization catalyst component; (ii) maintaining the slurry in the catalyst feed vessel in a homogeneous state; (iii) continuously withdrawing a portion of the catalyst slurry from the catalyst feed vessel and introducing the withdrawn slurry into a polymerization reactor.

WO 2010/086392 A1 describes a method for transitioning between two different catalysts during a continuous olefin polymerization, more specifically in the production of polypropylene homo- or copolymers in a continuous slurry/gas phase polymerization reaction with a prior pre-polymerization reaction. The method comprises the steps of: a) discontinuing the feed of the first catalyst into the pre-polymerization reactor and then b) introducing the second catalyst into the prepolymerization reactor and c) adapting the reaction conditions in the prepolymerization reactor, the slurry reactor as well as in the subsequent gas phase reactor. The transition is performed between a Ziegler-Natta catalyst and a self-supported, solid metallocene catalyst, prepared by using an emulsion/solidification technology or vice versa and, whereby the transition is performed in the absence of any additional agent which deactivates or kills the catalyst.

The layout of the known feeding systems often has the disadvantage that the vessels are situated quite far from the injection point of the (pre)polymerization reactor. Consequently, in known systems according to the prior art catalyst feed lines plug from time to time due to length and/or complexity of the piping. Also pumps suffer from plugging during switchover from one tank to the other tank.

Thus, a process for feeding a polymerization catalyst into a polymerization reactor avoiding the mentioned disadvantages, in particular plugging, is desirable.

### SUMMARY OF THE INVENTION

The object is solved by a process for feeding a polymerization catalyst into a polymerization reactor, said process comprising the steps of:
(i) forming a catalyst slurry comprising oil and a solid catalyst component in a first catalyst preparation vessel;
(ii) transferring the catalyst slurry from the first catalyst preparation vessel to a first catalyst feed vessel;
(iii) maintaining the catalyst slurry in the first catalyst feed vessel in a homogeneous state;
(iv) withdrawing a portion of the catalyst slurry from the first catalyst feed vessel, preferably continuously withdrawing the catalyst slurry from the first catalyst feed vessel, and introducing the withdrawn portion of the catalyst slurry into a polymerization reactor;
   wherein the oil has a dynamic viscosity of from 25 to 1500 mPa*s at the conditions within the first catalyst preparation vessel and the first catalyst feed vessel and wherein the catalyst slurry is transferred along a substantially vertical path downwards from the first catalyst feed vessel to the reactor.

Catalyst preparation and catalyst feeding are made in different vessels. This allows to place the feeding vessel quite close to the polymerization reactor. The catalyst feed vessel is placed at a position above the polymerization reactor whereby the polymerization reactor can also be a prepolymerization reactor. In particular, the position above the polymerization reactor denotes a position above the injection point of the respective reactor. It is to be understood that due to the location of the catalyst feed vessel being above also covers positions which are located diagonally above the respective reactor. It is important that gravitational force supports the transport from the feed vessel to the injection point. Hence, plugging is avoided and the complexity of the feed pipes can be reduced. Also the strain on the pumps is reduced.

In addition to that, the system according to the present invention allows preparation of catalyst-oil slurry in the polyolefin plant from dry catalyst powder as the catalyst preparation vessel can be placed anywhere in the plant where the catalyst powder can easily be fed. For example, the preparation vessel may be located at a point, which is close to the ground as this simplifies feeding of the components. This generates savings in the catalyst transportation costs and reduces the time of feeding the catalyst powder to the system. On the other hand, catalyst-oil slurry preparation has the benefit that catalyst feeding in oil is very accurate and reliable with positive displacement pumps. Furthermore, oil is protecting the catalyst from catalyst poisons and makes handling of waste catalyst safer, especially with pyrophoric catalysts.

The layout of the vessels and the piping layout according to the present invention prevents plugging. Additionally, the invention allows plants to feed catalyst at higher slurry concentration and thereby reducing the amount of oil fed to the process.

The solid catalyst component to be applied in the inventive process is suspended in oil to produce catalyst slurry.

The oil is selected from the group consisting of food approved white oil and mixtures thereof; and/or the catalyst fed to the first catalyst preparation vessel is a dry catalyst powder; and/or the concentration of the catalyst in the slurry is between 10 to 40 wt. %, preferably between 15 and 30 wt. %, more preferably between 20 and 25 wt. % based on the total amount of slurry.

The oil to be used must be inert towards the catalyst. This means that it must not contain components having tendency to react with the catalyst, such as groups containing atoms selected from oxygen, sulphur, nitrogen, chlorine, fluorine, bromine, iodine and so on. Also groups containing double bonds or triple bonds should be avoided. Especially the presence of compounds like water, alcohols, organic sulphides, ketones, carbon monoxide, carbon dioxide and acetylenic compounds should be avoided.

The oil is preferably white oil, more preferably food approved white oil or mixtures of food approved white oils. The white oil may be white mineral oil. White mineral oil is a special mineral oil obtained by deep refining to remove impurities such as aromatic hydrocarbons, sulfur and nitrogen. It is generally composed of alkanes and naphthenes with a molecular weight of 250-400 g/mol, and belongs to the lubricating oil fraction. It is colourless, odourless, chemically inert and excellent in light and heat stability.

White mineral oil (i.e., white mineral oil, white oil) is often used as a diluent for the catalyst, particularly as a diluent for the polyolefin polymerization catalyst.

The food approved white oil may be food grade white oil. Food grade white oil is a special mineral oil product obtained by further refining and deducting aromatic hydrocarbons from ordinary white oil products. It has excellent photothermal stability, yellowing resistance, oxidation resistance and viscosity temperature performance, and is suitable for human body, safe and non-toxic. Examples of suitable food approved white oil are Clarion® Food Grade White Mineral Oil 70, Phillips 66® White Oil, FOODGUARD USP White Oil 15.

The viscosity of the oil should be such that stable slurry is obtained and the tendency of the catalyst particles to settle is minimal. Therefore, the oil should not have a too low viscosity. On the other hand, the slurry should be readily transportable into the polymerization reactor. A very high viscosity causes problems in catalyst handling, as highly viscous fluids need special operations in their handling. Moreover, the viscous wax remaining in the polymer product after the polymerization may have a negative effect on the product properties.

The kinematic viscosity of the oil in the catalyst slurry is preferably 65-75 mm 2/s. The kinematic viscosity of the oil are measured according to ISO 3104.

It has been found that the best results are obtained if the dynamic viscosity of the oil is from 25 to 1500 mPa*s at the conditions within the catalyst preparation vessel and the catalyst feed vessel. Preferably the dynamic viscosity is from 30 to 1500 mPa*s, more preferably from 35 to 990 mPa*s, when measured at the operating temperature of the feed vessel. The dynamic viscosity is the product of the kinematic viscosity and the density.

Especially, the viscosity of the oil should be sufficiently high to allow the operation of the feed pump. Moreover, the oil should lubricate the piston of the catalyst feed pump, to allow its smooth operation.

It has been surprisingly found that when the viscosity is selected within the range discussed above, the components of the catalyst slurry can be easily handled in various process operations, the catalyst particles have a minimal tendency to settle during their residence in the feed vessel and piping and a smooth operation of the feed pump is ensured.

The solid catalyst component may be delivered as a dry powder, or it may be delivered in oil slurry.

Preferably the catalyst fed to the catalyst preparation vessel is a dry catalyst powder.

If the catalyst is delivered as slurry, the oil used in the slurry is preferably the same as or at least similar to the oil used in the catalyst feed. The concentration of the solid catalyst component in the transport slurry may be up to 450 kg/m³.

The concentration of the solid catalyst component can be selected freely so that the desired catalyst feed rate is conveniently obtained. However, said concentration must not be too high, as otherwise it may be difficult to maintain a stable slurry. On the other hand, too low concentration may result in using excessive amount of oil, which may cause problems in increasing the level of extractable matters in the final polymer product.

The solid catalyst component may comprise polymer. Thus, it may have been prepolymerized to produce a minor amount of polymer on the solid catalyst component, for instance from 0.01 to 50 grams of polymer per gram of the solid component. The monomer used for prepolymerization may be the same as used in the polymerization reactor, or it may be different therefrom.

In the process of the present invention, the catalyst is selected from the group consisting of Ziegler-Natta catalysts, metallocene catalysts, late transition metal catalysts and mixtures thereof. Any solid catalyst component may be used in the process of the invention.

The catalyst may be of Ziegler-Natta type. For example, it may contain a magnesium compound and a titanium compound supported on an inorganic oxide carrier, as disclosed in EP 688794, WO 91/16361, WO 93/13141, WO 94/14857, WO 99/51646 and WO 01/55230. However, it may also contain a titanium compound supported on magnesium halide, as disclosed in WO 03/000756, WO 03/000757, WO 03/000754, WO 92/19653, WO 93/07182, WO 97/36939 and WO 99/58584. The catalyst may also be unsupported comprising particles of solid titanium trichloride, optionally containing additional components, such as aluminium trichloride.

The catalyst may also be a chromium catalyst, typically supported on silica. Such catalysts are disclosed, among others, in WO 99/52951 and WO 97/27225.

Further still, the catalyst may be a metallocene catalyst. Often such catalysts are supported, preferably on an inorganic oxide carrier, as disclosed in WO WO 96/32423, WO 98/32776 and WO 00/22011. However, the catalyst may also be prepared by forming the support from alumoxane and incorporating the metallocene compound on the alumoxane. Such a method of preparing solid metallocene catalyst components is disclosed in WO 03/051934.

The catalyst slurry may be formed in any method known in the art. According to a preferred method, the solid catalyst component is introduced into the oil under agitation.

The slurry is prepared in the first catalyst preparation vessel.

Preferably a homogenous slurry is prepared in the first catalyst preparation vessel. The homogeneous slurry is maintained by agitation. The agitation can be obtained by circulating the slurry by using a circulation pump and pipes connecting the pump to the first catalyst feed vessel. Alternatively, the first catalyst feed vessel is equipped with an agitator, which keeps the slurry within the feed vessel in motion. Preferably the first catalyst feed vessel is equipped with an agitator. The elements of the agitator should be chosen so that uniform stirring in the whole volume of the first catalyst feed vessel is obtained and no dead spots where the catalyst could settle exist. These stirrer elements, such as anchor type elements and axial and radial impellers are well known in the art and a person skilled in the art can choose a suitable combination for each geometry of the first catalyst feed vessel. The first catalyst feed vessel may also be equipped with baffles, which are known in the art to further improve the stirring.

As known to those familiar with the art, the revolution speed of the agitator N should be selected so that N≥Nⱼₛ, where Nⱼₛ is the just suspended speed and which can be calculated from correlations available in the art, for instance in Zwietering Th. N., “Suspending of solids particles in liquid by agitators”, Chem Eng Sci, Vol 8, pp 244-254, 1958. Preferably, the revolution speed of the agitator N is 50-75 rpm.

The pressure within the preparation(s) vessel is not critical. It can be selected within the operating range of the process equipment. Especially, it should be selected so that the pumps can be operated without problems. It is desired that the pressure in the preparation vessel(s) is higher than the atmospheric pressure to minimize eventual leaks of air and/or moisture into the preparation vessel(s).

The preparation vessel(s) must be maintained in inert atmosphere. Especially, the presence of oxygen and moisture should be avoided. Therefore, all the connections to the preparation vessel(s), such as pipe joints and agitator shaft bearings need to be carefully designed to eliminate the leaks from the atmosphere.

The gas phase in the preparation vessel(s) should preferably consist of nitrogen, argon or similar inert gases, or their mixtures. Also, the preparation vessel(s) should be equipped with the possibility to flush the vessel with inert gas, preferably with nitrogen.

Also, the process chemicals, such as the lubricating oil for the bearings, need to be selected so that they do not contain components that are harmful for the catalyst, or alternatively, their carryover into the preparation vessel(s) needs to be prevented.

In step (ii) the catalyst slurry is transferred from the first catalyst preparation vessel to the first catalyst feeding vessel via a catalyst transfer line.

Preferably the catalyst slurry is transferred from the first catalyst preparation vessel to the first catalyst feed vessel applying gas pressure or using a pump.

Further preferred, a second catalyst preparation vessel is present. In both preparation vessels the catalyst slurry can be formed independently.

The features of the first catalyst preparation vessel as described above apply also to the second catalyst preparation vessel.

Further preferred the catalyst slurry is transferred from the first catalyst preparation vessel and the second catalyst preparation vessel to the first catalyst feed vessel via a first catalyst transfer line. A second catalyst feed vessel may also be present to which the slurry can be transferred.

The temperature of the slurry within the catalyst feed vessel(s) is not critical. However, too low and too high temperatures should be avoided, as otherwise the viscosity of the slurry might either become too high so that it cannot be conveniently handled in the process or too low so that the particles tend to settle. The temperature may be selected in the range of from −30° C. to +80° C., preferably from 0° C. to 60° C.

It is preferred to equip the catalyst feed vessel(s) with a heating/cooling jacket so that the temperature in the vessel(s) can be maintained within the desired level. Especially, the temperature of the slurry should be adjusted so that the viscosity of the oil would be within the desired limits. Moreover, temperature variations should be avoided; they cause variations in the density of the slurry. If the density of the slurry varies, then the catalyst feed rate shall vary accordingly and this could cause fluctuations in the polymerization process.

The feed rate is controlled based on the catalyst and production rate. The feed rate is as stable as possible.

The pressure within the catalyst feed vessel(s) is not critical. It can be selected within the operating range of the process equipment. Especially, it should be selected so that the pumps can be operated without problems. It is desired that the pressure in the catalyst feed vessel(s) is higher than the atmospheric pressure to minimize eventual leaks of air and/or moisture into the catalyst feed vessel(s).

The catalyst feed vessel(s) must be maintained in inert atmosphere. Especially, the presence of oxygen and moisture should be avoided. Therefore, all the connections to the feed vessel(s), such as pipe joints and agitator shaft bearings need to be carefully designed to eliminate the leaks from the atmosphere.

Also, the process chemicals, such as the lubricating oil for the bearings, need to be selected so that they do not contain components that are harmful for the catalyst, or alternatively, their carryover into the catalyst feed vessel(s) needs to be prevented. It is especially preferred to use as the lubricating oil the same oil that is used as a diluent in the catalyst slurry.

The gas phase in the catalyst feed vessel(s) should preferably consist of nitrogen, argon and similar inert gases, or their mixtures. Also, the catalyst feed vessel(s) should be equipped with possibility to flush the vessel(s) with inert gas, preferably with nitrogen.

Optionally, the catalyst slurry is contacted with an activator and/or an electron donor in the preparation vessel or before it is introduced into the polymerization reactor or it is introduced into the line before the polymerization reactor.

The catalyst slurry may contain additional components, such as activators, electron donors, modifiers, antistatic agents and so on. If such components are used, they may be combined with the catalyst slurry in the catalyst feed vessel(s), or they may be combined with the catalyst slurry stream to be introduced into the polymerization reactor, or they may be introduced directly into the polymerization reactor without precontacting them with the catalyst slurry.

As useful activators can be mentioned the organometal compounds, such as the organoaluminium compounds and in specific the aluminium alkyls. Examples of such preferred compounds are trimethylaluminium, triethylaluminium, tri-isobutylaluminium, tri-n-hexylaluminium, tri-n-octylaluminum and isoprenyl aluminium. Other useful compounds are methylalumoxane, tri-isobutylalumoxane, hexa-isobutylalumoxane and other alumoxanes, dimethylaluminium chloride, diethylaluminium chloride, methylaluminium sesquichloride, ethylaluminium sesquichloride, diethyl zinc and triethyl boron.

As examples of electron donors ethers, esters, ketones, alcohols, carboxylic acids, silicon ethers, imides, amides and amines may be mentioned.

It is further possible to add into the catalyst slurry a small amount of a drag reducing agent. Such drag reducing agents are typically soluble polymers of high alpha-olefins, like C₆ to C₁₅ alpha-olefins, preferably C₈ to C₁₃ alpha-olefins, and their mixtures. They may comprise a minor amount of comonomer units derived from other olefins as well. It is important, however, that the drag reducing agent is soluble in the oil. The drag reducing agent is used in an amount of 0.1 to 1000 ppm, preferably 0.5 to 100 ppm and more preferably 1 to 50 ppm by weight of the catalyst slurry. It has been found that already this small amount reduces the settling tendency of the slurry. While an excess amount of the drag reducing agent has no drawback from the process point of view, it should be borne in mind that the drag reducing agent shall remain with the polymer product and it may have a negative effect in some product properties if used in large quantities.

Drag reducing agents are available on the market and they are supplied, among others, by M-I Production Chemicals and Conocon. The former supplies a product with a trade name NECADD 447™, which has been found to be useful in preventing the settling of the catalyst particles. The drag reducing agent typically has a weight average molecular weight of at least 250,000 g/mol, preferably at least 500,000 g/mol and more preferably at least 800,000 g/mol. In particular, the drag reducing agent has a weight average molecular weight of more than 1,000,000 g/mol.

According to a preferred embodiment, in the process of the present invention a second catalyst preparation vessel, a first catalyst feed vessel and a second catalyst feed vessel are applied, wherein the catalyst slurry of the first catalyst preparation vessel is transferred to the first catalyst feed vessel via a first catalyst transfer line and the catalyst slurry of the second catalyst preparation vessel is transferred to the second catalyst feed vessel via a second catalyst transfer line.

The features of the first catalyst preparation vessel as described above apply also to the second catalyst preparation vessel.

A process with two catalyst preparation vessels and two catalyst feed vessels with separated transfer lines can improve the operating flexibility, which leads to an improved capacity of the process. Further, the process may comprise two catalyst preparation vessels and two catalyst feed vessels with non-separated, preferably crossing transfer lines.

Said crossing transfer lines comprise a switching system. The first and second feed lines may also cross each other and may also comprise a switching system. The switching systems can switch between using the first or second transfer line to transfer the catalyst slurry from the first or second catalyst preparation vessel to the first or second catalyst feed vessel and between using the first or second feed line to transfer the withdrawn portion of the catalyst slurry from the first or second catalyst feed vessel to the polymerization reactor. Preferably the switching system comprises two or more valves.

The catalyst slurry is maintained in homogeneous state (step (iii)).

Portions of the slurry can continuously be withdrawn from the catalyst feed vessel(s) and introduced into a polymerization reactor.

In step (iv) the catalyst slurry is transferred from the first catalyst feed vessel and/or the second catalyst vessel into the polymerization reactor by using at least one valveless piston pump. The valveless piston pump is located at a level which is below the level of the catalyst feed vessel.

A valveless piston pump is ideal for applications with high viscosities as well as fluids with particulate or colloidal systems. Valveless piston pumps work extremely accurate.

In the process of the present invention, the transport from the first catalyst preparation vessel to the first catalyst feed vessel and/or from the second catalyst preparation vessel to the second catalyst feed vessel can be done batchwise, preferably is done batchwise. So the velocity in the pipe can be so high that no settling can occur.

In the process of the present invention, the at least one transfer line can be emptied using oil and/or Nz. The transfer line from the catalyst preparation vessel to the catalyst feed vessel operates pneumatically with the Nz-pressure.

Preferably the catalyst slurry withdrawn from the catalyst feed vessel(s) and introduced into the polymerization reactor is transferred via at least one feed line from the catalyst feed vessel(s) to the polymerization reactor.

Preferably the at least one feed line has a length of from 2 to 12 m, preferably all feed lines have a length of from 2 to 12 m. Even more preferably the at least one feed line has a length of from 5 to 12 m and more preferably from 10 to 12 m.

Optionally, the process of the present invention comprises the step of monitoring the level of the catalyst slurry by means of a level sensor in the catalyst feed vessel(s), preferably the first catalyst feed vessel and the second catalyst feed vessel. Additionally, a level measurement may be configured in the catalyst preparation vessel(s) and/or the step of monitoring the level of the catalyst slurry by means of a level sensor in the catalyst preparation vessel(s), preferably the first catalyst preparation vessel and the second catalyst preparation vessel.

The level sensor equipped in the catalyst feed vessel(s) is capable of estimating the level of the catalyst slurry. For instance, radioactive level measurement instruments may be used. They can be used both for measuring the level of the concentrated (or settled) slurry in the feed vessel(s) and the level of homogeneous slurry. By using the level sensor the operators can prepare a new batch of catalyst slurry in the preparation vessel(s). When the catalyst slurry (or the concentrated catalyst slurry) in the first catalyst feed vessel comes to an end then the operators can either stop the catalyst slurry withdrawal from the first catalyst feed vessel and start it from the second catalyst feed vessel, or alternatively transfer a new batch of catalyst slurry into the catalyst feed vessel from the preparation vessel.

It is also possible to transfer small portions of slurry from the preparation vessel(s) to the catalyst feed vessel(s) either continuously or intermittently. When using such procedure it is possible to keep the level of the catalyst slurry or concentrated catalyst slurry substantially constant in the catalyst feed vessel(s).

In the present system further sensors that can be installed, are for example gas sensor(s), pressure sensor(s), temperature sensor(s) and electrostatic sensor(s).

The present invention provides the additional steps of stopping the withdrawal of the catalyst slurry from one of the first catalyst feed vessel or the second catalyst feed vessel, and starting the withdrawal of the catalyst slurry from the other one of the first catalyst feed vessel or the second catalyst feed vessel in response to the signal from the level sensor.

In a further aspect the present invention relates to a process for producing olefin polymers in a polymerization reactor comprising the steps of feeding the polymerization catalyst into the polymerization reactor by using the process as described above.

Preferably the process for producing olefin polymers in a polymerization reactor comprises the steps of feeding the polymerization catalyst into the polymerization reactor by using the above mentioned process. Said process comprising the steps of
(i) continuously introducing at least one olefin monomer into the polymerization reactor;
(ii) optionally, continuously introducing diluent and/or hydrogen into the polymerization reactor;
(iii) operating the polymerization reactor in such conditions that the at least one olefin monomer is polymerized by the polymerization catalyst to form a reaction mixture containing the catalyst, unreacted monomer(s), formed polymer and optionally diluent and/or hydrogen; and
(iv) optionally, withdrawing a portion of the reaction mixture from the polymerization reactor.

In some cases it is preferred that the polymerization stage is preceded by a prepolymerization stage. In prepolymerization a small amount of an olefin, preferably from 0.1 to 500 grams of olefin per one gram catalyst is polymerized. Usually the prepolymerization takes place at a lower temperature and/or lower monomer concentration than the actual polymerization. Typically, the prepolymerization is conducted from 0 to 70° C., preferably from 10 to 60° C. Usually, but not necessarily, the monomer used in the prepolymerization is the same that is used in the subsequent polymerization stage(s). It is also possible to feed more than one monomer into the prepolymerization stage. Description of prepolymerization can be found in e.g. WO 96/18662, WO 03/037941, GB 1532332, EP 517183, EP 560312 and EP 99774.

In the polymerization process alpha-olefins of from 2 to 20 carbon atoms can be polymerized. Especially ethylene and/or propylene, optionally together with higher alpha-olefins are polymerized. 1-butene and 1-hexene are preferred as comonomers.

The diluent may be any liquid which is inert towards the catalyst. Suitable diluents are hydrocarbons having at least 3 carbon atoms. Preferably the diluent is selected from the group consisting of C₃ to C₁₀ hydrocarbons and the mixtures thereof. In particular, the diluent is selected from the group consisting of propane, n-butane, isobutane, n-pentane, isopentane and the mixtures thereof.

It is within the scope of the invention to conduct the polymerization in at least one polymerization stage. It is also known in the art to polymerize in at least two polymerization stages to produce bimodal polyolefins, such as bimodal polyethylene and bimodal polypropylene, as disclosed in WO 92/12182, EP 22376, EP 713888 and WO 98/58975. Further, multistage polymerization may be used to produce heterophasic propylene copolymers, as disclosed in WO 98/58976. It is to be understood that the present invention is not limited to any specific number of polymerization stages, but any number is possible.

If the polymerization is conducted as a slurry polymerization, any suitable reactor type known in the art may be used. A continuous stirred tank reactor and a loop reactor are suitable examples of useful reactor types. Especially, a loop reactor is preferred because of its flexibility.

The slurry polymerization may be conducted in normal liquid slurry conditions or alternatively so that the temperature and the pressure within the reactor exceed the critical temperature and pressure of the fluid mixture within the reactor. Such a polymerization method is called supercritical slurry polymerization. Description of liquid slurry polymerization is given, among others, in EP 249689 and U.S. Pat. No. 3,262,922 and supercritical slurry polymerization in WO 92/12181 and U.S. Pat. No. 3,294,772.

The slurry may be withdrawn from the reactor in any method known in the art, including continuous and intermittent withdrawal. If the withdrawal is intermittent, it may be realized by using so called settling legs, where the slurry is allowed to settle before discharging the settled slurry from the reactor. Settling legs are generally known in the art and they are described, for instance, in U.S. Pat. Nos. 4,613,484 and 4,121,029.

If the slurry is withdrawn continuously from the reactor, then it may be withdrawn without a concentration step or it may be concentrated either before or after the withdrawal. For economic reasons it is preferred to concentrate the slurry. Suitable methods of concentration are, among others, hydrocyclone or sieve. Typically in such a method the slurry is withdrawn continuously from the reactor and passed through a concentration device, such as hydrocyclone or sieve. The bottom flow is directed to product withdrawal whereas the overflow is recycled to the polymerization reactor. Such methods are disclosed in EP 1415999.

In a further aspect the present invention provides an olefin polymer obtainable by the process for producing olefin polymers in a polymerization reactor comprising the steps of feeding the polymerization catalyst into the polymerization reactor by using the inventive process as described above.

An olefin polymer is obtainable by the above described process. The polymers obtained from the process include all olefin polymers and copolymers known in the art, such as high density polyethylene (HDPE), medium density polyethylene (MDPE), linear low density polyethylene (LLDPE), polypropylene homopolymers, random copolymers of propylene and ethylene or propylene and higher alpha-olefins, heterophasic copolymers of propylene and ethylene, poly-1-butene and poly-4-methyl-1-pentene. When higher alpha-olefins are used as comonomers, they are preferably selected from the group consisting of 1-butene, 1-hexene, 4-methyl-1-pentene, 1-octene and 1-decene.

In another aspect, the present invention provides a catalyst slurry feeding system for producing olefin polymers in a polymerization reactor comprising
a first catalyst preparation vessel, preferably at least two catalyst preparation vessels, for forming a catalyst slurry comprising oil and a solid catalyst component;
a first catalyst feed vessel, preferably at least two catalyst feed vessels, for maintaining the catalyst slurry in a homogenous state;
a polymerization reactor;
a first transfer line connecting the first catalyst preparation vessel to the first catalyst feed vessel, preferably at least two transfer lines connecting the at least two catalyst preparation vessels to the at least two catalyst feed vessels;
a first feed line connecting the first catalyst feed vessel to the polymerization reactor, preferably at least two feed lines connecting the at least two catalyst feed vessels to the polymerization reactor;
   wherein the first feed line is provided with a pump, preferably the at least two feed lines are provided with at least one pump, and the first catalyst feed vessel is located above the polymerization reactor, preferably the at least two catalyst feed vessels are located above the polymerization reactor.

Preferably the catalyst slurry feeding system for producing olefin polymers in a polymerization reactor comprises a second catalyst preparation vessel and wherein the first catalyst preparation vessel is connected to a first catalyst feed vessel via a first transfer line and the second catalyst preparation vessel is connected to a second catalyst feed vessel via a second transfer line.

Preferably the first feed line has a length of from 2 to 12 m, preferably all feed lines have a length of from 2 to 12 m. Even more preferably the first feed line and/or the at least two feed lines, have a length of from 5 to 12 m and more preferably from 10 to 12 m.

The feed lines may be equipped with a catalyst flow meter. Flow meters suitable for measuring the catalyst feed rate are disclosed in WO 2004/057278 or are commercially available, among others, from Oxford Instruments. Such a flow meter may also be used as a part of a control loop to control the catalyst feed rate. For example, a signal from the flow meter is compared with a predetermined set value, and the signal to the metering pump is adjusted based on the difference.

The above mentioned system allows the separation of the function of catalyst preparation and its feeding to the process. Hence, the catalyst preparation vessel(s) can be of some distance to the injection point of the polymerization reactor and the catalyst feed vessel(s) can be located as close as possible to the injection point of the polymerization reactor. By placing the catalyst feed vessel(s) above the polymerization reactor, gravitational force supports the transport of the catalyst slurry to the polymerization reactor.

Preferably, the catalyst feed vessel(s) is located at a position above the injection point of the polymerization reactor.

Preferably, the catalyst feed vessel(s) is located vertically above or diagonally above the polymerization reactor, more preferably the at least two catalyst feed vessels are located vertically or diagonally above the polymerization reactor.

The position of the preparation vessel(s) can be selected freely. Usually, the position of the preparation vessel(s) depends on the structure of the overall system. Besides, the position is regularly selected so that the feeding of the preparation vessel(s) is simplified. However, the preparation vessel(s) can be placed at a position below the level of the catalyst feed vessel(s). Preferably, the preparation vessel(s) are located at a position below the catalyst feeding vessel(s).

Such a system with two catalyst preparation vessels and two catalyst feed vessels with separated transfer lines can improve the capacity of the production of olefin polymers.

All embodiments discussed with respect to the process for feeding a polymerization catalyst into a polymerization reactor also apply to the catalyst slurry feeding system for producing olefin polymers.

FIG. 1 shows a system of the inventive process including a catalyst preparation vessel, a catalyst feed vessel, a catalyst feed pump and a polymerization reactor.

FIG. 2 shows another system of the inventive process including two catalyst preparation vessels, two catalyst feed vessels, two catalyst feed pumps and a polymerization reactor.

FIG. 3 shows a system of the inventive process with crossing transfer lines, crossing feed lines and two switching systems.

Unless explicitly described otherwise, the description of the present invention is to be understood so that one or more of any of the above described preferred embodiments of the invention can be combined with the invention described in its most general features. In addition, it will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the present claims.

### DESCRIPTION OF THE FIGURES

FIG. 1 shows an example of the inventive process. The process includes a catalyst preparation vessel (1), a catalyst feed vessel (3), a catalyst feed pump (4) and a polymerization reactor (6). The catalyst preparation vessel (3) can be located on ground level for easy access. In the catalyst preparation vessel (1) the catalyst slurry is formed and then said catalyst slurry is transferred to the catalyst feed vessel (3) via a catalyst transfer line 2. The transport from the catalyst preparation vessel to the catalyst feed vessel can be done batchwise. Preferably the catalyst feed vessel (3) is located at a level which is above the level of the catalyst preparation vessel (1). Thereby the transfer of the catalyst slurry from the catalyst preparation vessel (1) to the catalyst feed vessel (3) occurs substantially upwards. Meanwhile, the catalyst slurry in a homogeneous state, is withdrawn from the bottom of the operating catalyst feed vessel (3). The withdrawn portion of the catalyst slurry is transferred by using for example a valveless piston pump (4) via the feed line (5) to the polymerization reactor (6). The catalyst feed vessel (3) is located above the polymerization reactor (6).

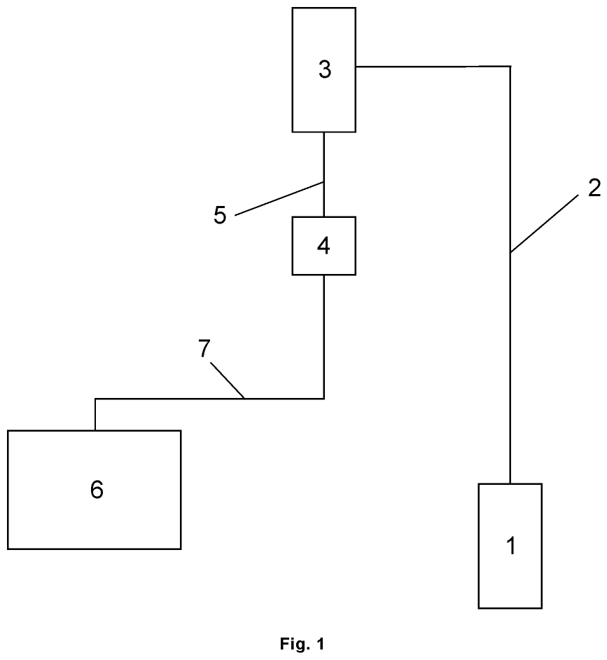

FIG. 2 shows another embodiment of the inventive process. This process includes two catalyst preparation vessels (11,12), two catalyst feed vessels (31,32), two catalyst feed pumps (41,42) and a polymerization reactor (6). The catalyst slurry of the first catalyst preparation vessel (11) is transferred to the first catalyst feed vessel (31) via a first catalyst transfer line (21) and the catalyst slurry of the second catalyst preparation vessel (12) is transferred to the second catalyst feed vessel (32) via a second catalyst transfer line (22). Preferably the catalyst feed vessels (31,32) are located at a level which is above the level of the polymerization reactor (6). The withdrawn portions of the catalyst slurry from the catalyst feed vessels (31,32) are transferred via the two feed lines (51,52) to for example two valveless piston pumps (41,42) and then transferred via the two reactor feed lines (71,72) to the polymerization reactor (6).

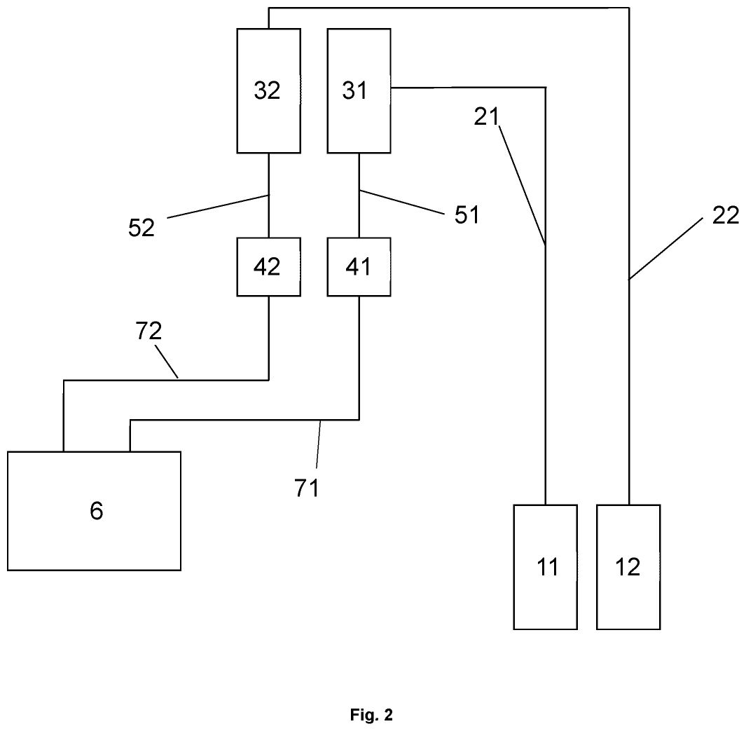

FIG. 3 shows another embodiment of the inventive process. FIG. 3 shows a flow sheet which is similar to the system shown in FIG. 2. However, in the system shown in FIG. 3 the first and second catalyst transfer lines (211,212 & 221,222) connecting the first and the second catalyst preparation vessel (11,12) and the first and second catalyst feed vessels (31,32) cross each other. The first and second feed lines (511,512 & 521,522) from the first and second catalyst feed vessels (31,32) to the valveless piston pumps (41,42) are also crossing each other.

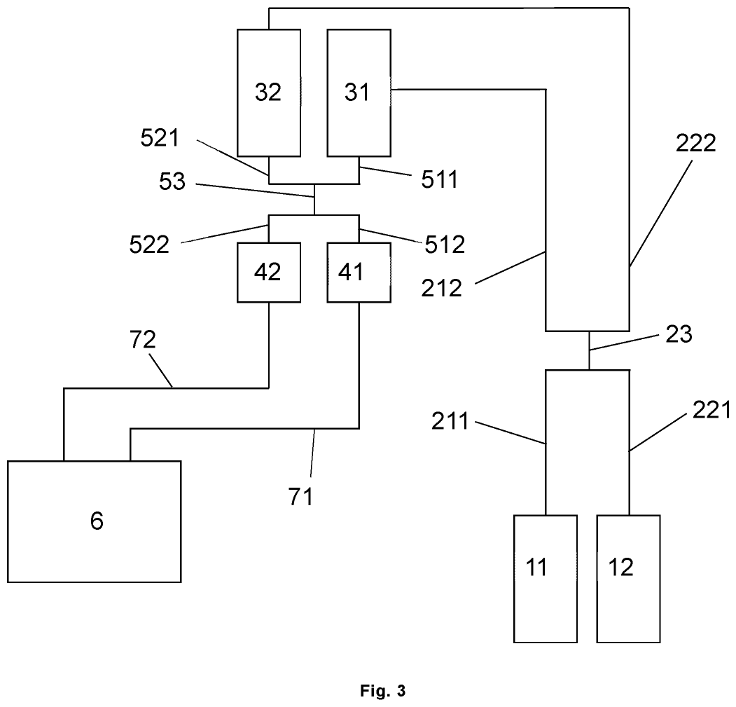

The catalyst slurry of the first catalyst preparation vessel (11) is transferred to the first catalyst feed vessel (31) via a first catalyst transfer line (211,212), thereby passing a first switching system (23), which is located between the first part of the first transfer line (211) and the second part of the first transfer line (212). The switching system (23) comprises two or more valves and can be set so that the catalyst slurry is transferred via the second part of the first catalyst transfer line (212) to the first catalyst feed vessel (31) or via the second part of the second catalyst transfer line (222) to the second catalyst feed vessel (32). The catalyst slurry of the second catalyst preparation vessel (12) is transferred to the first catalyst feed vessel (32) via the first part of the first catalyst transfer line (221) thereby passing the first switching system (23). The first switching system (23) can be set so that the catalyst slurry is transferred via the second part of the second catalyst transfer line (222) to the second catalyst feed vessel (32) or via the second part of the first catalyst transfer line (212) to the first catalyst feed vessel (31).

The withdrawn portions of the catalyst slurry from the catalyst feed vessels (31,32) are transferred via the first and second feed lines (511,512 & 521,522) and a second switching system (53) to the valveless piston pumps (41,42) and then transferred via the two reactor feed lines (71,72) to the polymerization reactor (6). The withdrawn portion from the catalyst feed vessel (31) is transferred via the first part of the first feed line (511) to the second switching system (53) and then via the second part of the first feed line (512) to the valveless piston pump (41) or via the second part of the second feed line (522) to the other valveless piston pump (42). The withdrawn portions from the catalyst feed vessel (32) can be transferred via the first part of the second feed line (521) to the second switching system (53) and then via the second part of the second feed line (522) to the valveless piston pump (42) or via the second part of the first feed line (512) to the other valveless piston pump (41). The desired lines can be selected via the switching systems. This process provides even more flexibility with respect to the preparation and feeding of catalyst slurry.

### LIST OF REFERENCE SKINS

1 catalyst preparation vessel
11 first catalyst preparation vessel
12 second catalyst preparation vessel
2 catalyst transfer line
21 first catalyst transfer line
211 first part of first catalyst transfer line
212 second part of first catalyst transfer line
22 second catalyst transfer line
221 first part of second catalyst transfer line
222 second part of second catalyst transfer line
23 first switching system
3 catalyst feed vessel
31 first catalyst feed vessel
32 second catalyst feed vessel
4 catalyst feed pump
41 first catalyst feed pump
42 first catalyst feed pump
5 feed line
51 first feed line
511 first part of first feed line
512 second part of first feed line
52 second feed line
521 first part of second feed line
522 second part of second feed line
53 second switching system
6 polymerization reactor
7 reactor feed line
71 first reactor feed line
72 second reactor feed line

1. A process for feeding a polymerization catalyst into a polymerization reactor, said process comprising the steps of:
(i) forming a catalyst slurry comprising oil and a solid catalyst component in a first catalyst preparation vessel;
(ii) transferring the catalyst slurry from the first catalyst preparation vessel to a first catalyst feed vessel;
(III) maintaining the catalyst slurry in the first catalyst feed vessel in a homogeneous state;
(iv) withdrawing a portion of the catalyst slurry from the first catalyst feed vessel and introducing the withdrawn portion of the catalyst slurry into a polymerization reactor;
wherein the oil has a dynamic viscosity of from 25 to 1500 mPa*s at the conditions within the first catalyst preparation vessel and the first catalyst feed vessel,
wherein the catalyst slurry is transferred along a substantially vertical path downwards from the first catalyst feed vessel to the reactor.

2. The process according to claim 1 comprising a second catalyst preparation vessel and wherein the catalyst slurry from the first catalyst preparation vessel and the second catalyst preparation vessel is transferred to the first catalyst feed vessel via a first catalyst transfer line.

3. The process according to claim 1 comprising a second catalyst preparation vessel, a first catalyst feed vessel and a second catalyst feed vessel, wherein the catalyst slurry of the first catalyst preparation vessel is transferred to the first catalyst feed vessel via a first catalyst transfer line and the catalyst slurry of the second catalyst preparation vessel is transferred to the second catalyst feed vessel via a second catalyst transfer line.

4. The process according to claim 1,
wherein the catalyst slurry from the first catalyst feed vessel and/or the second catalyst feed vessel is transferred into the polymerization reactor by using at least one valveless piston pump; and/or
wherein the catalyst feed vessel(s) are located vertically above or diagonally above the polymerization reactor.

5. The process according to claim 1,
wherein the oil is white oil; and/or
wherein the oil has a dynamic viscosity of from 30 to 1500 mPa*s at the conditions within the first catalyst preparation vessel and/or the second catalyst preparation vessel and the first catalyst feed vessel and/or the second catalyst feed vessel; and/or
wherein the catalyst fed to the first catalyst preparation vessel and/or the second catalyst preparation vessel is a dry catalyst powder; and/or
wherein the concentration of the catalyst in the slurry is between 10 to 40 wt. %, based on the total amount of slurry.

6. The process according to claim 1, wherein the catalyst is selected from the group consisting of Ziegler-Natta catalysts, metallocene catalysts, late transition metal catalysts and mixtures thereof.

7. The process according to claim 1, wherein the transport from the first catalyst preparation vessel to the first catalyst feed vessel and/or from the second catalyst preparation vessel to the second catalyst feed vessel is done batchwise.

8. The process according to claim 2, wherein the at least one transfer line can be emptied using oil and/or N₂.

9. The process according to claim 3 comprising the step of monitoring the level of the catalyst slurry by means of a level sensor in the first catalyst feed vessel and the second catalyst feed vessel; and/or the step of monitoring the level of the catalyst slurry by means of a level sensor in the first catalyst preparation vessel and the second catalyst preparation vessel.

10. The process according to claim 9 comprising the steps of
stopping the withdrawal of the catalyst slurry from one of the first catalyst feed vessel and the second catalyst feed vessel, and
starting the withdrawal of the catalyst slurry from the other one of the first catalyst feed vessel and the second catalyst feed vessel in response to the signal from the level sensor.

11. A process for producing olefin polymers in a polymerization reactor comprising the steps of feeding the polymerization catalyst into the polymerization reactor by using the process of claim 1.

12. The process for producing olefin polymers in a polymerization reactor according to claim 11 comprising the steps of
(i) continuously introducing at least one olefin monomer into the polymerization reactor;
(ii) optionally, continuously introducing diluent and/or hydrogen into the polymerization reactor;
(iii) operating the polymerization reactor in such conditions that the at least one olefin monomer is polymerized by the polymerization catalyst to form a reaction mixture containing the catalyst, unreacted monomer(s), formed polymer and optionally diluent and/or hydrogen; and
(iv) optionally, withdrawing a portion of the reaction mixture from the polymerization reactor.

13. An olefin polymer obtainable by the process according to claim 11.

14. A catalyst slurry feeding system for producing olefin polymers in a polymerization reactor comprising
a first catalyst preparation vessel for forming a catalyst slurry comprising oil and a solid catalyst component;
a first catalyst feed vessel for maintaining the catalyst slurry in a homogenous state;
a polymerization reactor;
a first transfer line connecting the first catalyst preparation vessel to the first catalyst feed vessel;
a first feed line connecting the first catalyst feed vessel to the polymerization reactor;
wherein the first feed line is provided with a pump; and
wherein the first catalyst feed vessel is located above the polymerization reactor.

15. The system according to claim 14,
wherein the system comprises a second catalyst preparation vessel and
wherein the first catalyst preparation vessel is connected to a first catalyst feed vessel via a first transfer line and the second catalyst preparation vessel is connected to a second catalyst feed vessel via a second transfer line; and/or
wherein the catalyst feed vessel(s) is located at a point above the injection point of the polymerization reactor.

16. The process according to claim 1, wherein the withdrawing comprises continuously withdrawing the catalyst slurry from the first catalyst feed vessel.

17. The process according to claim 5, wherein the oil is food approved white oil.

18. The process according to claim 5, wherein the oil has a dynamic viscosity of from 35 to 990 mPa*s.

19. The process according to claim 5, wherein the concentration of the catalyst in the slurry is between 15 and 30 wt. %.

20. The process according to claim 5, wherein the concentration of the catalyst in the slurry is between 20 and 25 wt. %.
